(19) United States
(12) Patent Application Publication
(10) Pub. No.: US 2010/0254748 A1
(43) Pub. Date: Oct. 7, 2010

(54) FINGER PEN

(76) Inventor: Te-Lin LI, Yingge Township (TW)

Correspondence Address: Muncy, Geissler, Olds & Lowe, PLLC, 4000 Legato Road, Suite 310, FAIRFAX, VA, 22033, US

(21) Appl. No.: 12/419,461

(22) Filed: Apr. 7, 2009

(51) Int. Cl. B43K 7/12

(52) U.S. Cl. 401/109

(57) ABSTRACT

A finger pen includes a sheath and a spring clip. An end of the sheath is an opening for sheathing in a finger, and the other end is a hole allowing the pen to penetrate. A spacing hole is close to the hole, the spring clip is fixed on the sheath, and a stop block is located on the spring clip, away from a place where the spring clip is fixed, to be engaged with the spacing hole. A back side of the spring clip, close to the stop block, is a fixing piece to fix the pen. When the finger pen is to be used, the finger is sheathed into the sheath, and at a same time, the finger is abutted at the spring clip to push and move the stop block toward the hole out of which the pen is penetrated to write.

### BACKGROUND OF THE INVENTION

a) Field of the Invention

The present invention relates to a finger pen, and more particularly to a finger pen which is compact and convenient without taking up space, and is pretty.

b) Description of the Prior Art

To facilitate a user to hold to write, a conventional pen structure is formed by a penholder of a fixed length assembled with a thin and long refill. According to the penholder structure, the refill can be generally divided into an automatic retractable pen or an ordinary pen sheathed with a pen cap. Disregarding the structure, the conventional pen structure should always be provided with a penholder of a certain length to be held that writing can be carried out. Therefore, not only that a profile is limited to a long rod of a certain length, but also that the pen should be held to use. Accordingly, other than that there may have improvement to the retractable structure of the refill, the existing model cannot be broken through totally, that improvement cannot be further made to writing control and a penholder of a certain length should be provided inevitably. In other words, for the existing pen, its size and writing method are still fixed, and more creative pens have not been seen yet.

In addition, in a modern society that time is money, if one can control the time, then business opportunity can be controlled. No wonder that there are more and more merchandises which provide convenience in use and are equipped with multiple functions. For example, a cell phone, which is the most popular merchandise now, has been improved from a huge device like the Motorola 9810 in the beginning, to the recent PDA (Personal Digital Assistant) which is provided with computer-like functions. Another example is a portable laptop computer. All these prove that the merchandises are superior from one generation to next, and can more facilitate us to use. On the other hand, the existing pen has to be taken out deliberately for use from a pen container or a place where the pen is emplaced, and needs to be put back or set aside while not in use that a work at hand can be continued. Moreover, if the pen is still held on a hand, then it will be inconvenient to work, definitely causing great deal of inconvenience for a person who needs to take notes with a pen occasionally and needs to work with the hand occasionally.

### SUMMARY OF THE INVENTION

The primary object of the present invention is to provide a finger pen which includes a sheath, an end of which is provided with an opening, and the other end of which is provided with a hole. A spacing hole is provided at a place close to the hole, a flexible spring clip is fixed on the sheath, and a stop block is provided at the spring clip, away from a place where the spring clip is fixed, to be engaged with the spacing hole. A back side of the spring clip, close to the stop block, is provided with a fixing piece to fix the pen, and a proper position of the spring clip is provided with plural ridges which facilitate a finger to push and move the spring clip. In addition, the sheath is provided with a ventilation hole for ventilation. By the aforementioned structures, when the finger of a user is sheathed into the sheath, the spring clip can be pushed and moved toward the hole, with the ridges and the stop block as a push interface. In a mean time, the pen will penetrate out of the hole when pushing and moving the spring clip, thereby achieving an object of writing. By the aforementioned technology, the issues of the conventional pen that the pen should be taken out deliberately for use from the pen container or the place where the pen is emplaced, needs to be put back or set aside while not in use, and the work will be inconvenient if the pen is still held on the hand, can be broken through, so as to achieve practical progressiveness that by sheathing the finger into the sheath, one can proceed writing, without deliberately taking the pen out of the pen container or resulting in leak of ink by forgetting to put on the pen cap, and that market competitiveness can be enhanced as the present invention can be produced rapidly in a large quantity due to a small size and simple structures.

Another object of the present invention is to provide a finger pen which includes a sheath, a side of which is further provided with a fixing ring, with the fixing ring being connected with a strap made by a stretchable material. Accordingly, the strap can be provided on a cell phone, a purse and a hand bag, or can be used as a necklace, which facilitates the user to read or write and can be further used for decorating.

Still another object of the present invention is to provide a finger pen which includes sheath, a side of which is further provided with a magnetic fastener, with the magnetic fastener being connected with a snap ring and a rope. When the user is to use that magnetic fastener, the sheath can be further connected on a bag or oneself through the magnetic fastener. In addition, while using the pen, one can easily take out the sheath to use without restriction and can absorb the sheath back to the magnetic fastener when not in use.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows an exploded view of a preferred embodiment of the present invention.

FIG. 3 shows a first schematic view of an operation of a preferred embodiment of the present invention.

FIG. 4 shows a second schematic view of an operation of a preferred embodiment of the present invention.

FIG. 5 shows a schematic view of an implementation of a first preferred embodiment of the present invention.

FIG. 6 shows a schematic view of an implementation of a second preferred embodiment of the present invention.

FIG. 7 shows a schematic view of an implementation of a third preferred embodiment of the present invention.

FIG. 8 shows a schematic view of an implementation of a fourth preferred embodiment of the present invention.

### DETAILED DESCRIPTION OF THE PREFERRED EMBODIMENTS

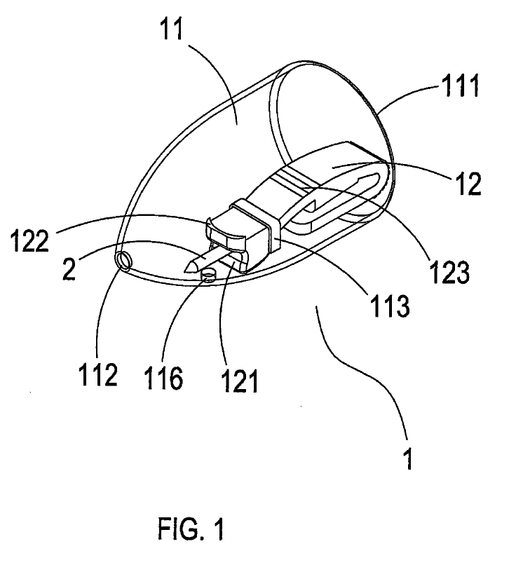

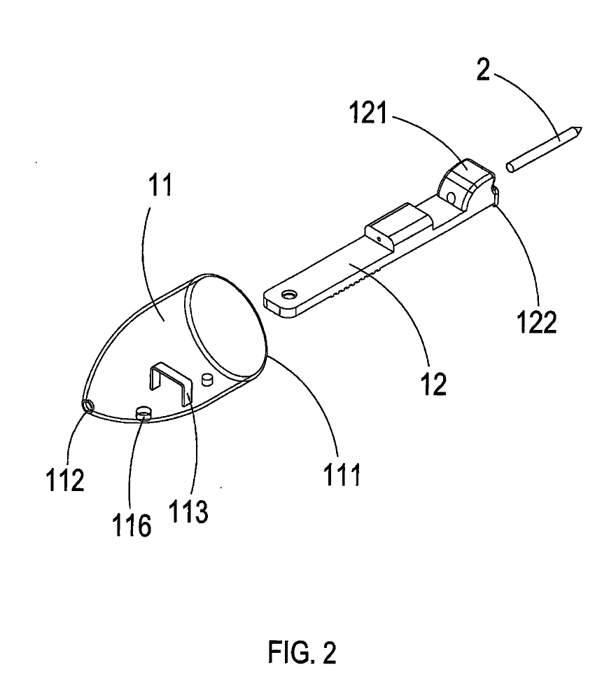

Referring to FIG. 1 and FIG. 2, it shows a three-dimensional view and an exploded view of a preferred embodiment of the present invention, wherein a finger pen 1 of the present invention comprises a sheath 11, an end of which is provided with an opening 111 for sheathing in a finger, and the other end of which is provided with a hole 112 allowing a pen 2 to penetrate, with a spacing hole 113 being provided at a place close to the hole 112; and a spring clip 12, an end of which is fixed on the sheath 11, a back side at the other end of which is provided with a fixing piece 121 to fix the pen 2, and which is provided with a stop block 122 away from a place where the spring clip 12 is fixed to be engaged with the spacing hole 113. Moreover, as the spring clip 12 is made by a flexible material, elasticity is produced by bending the spring clip 12, allowing the pen 2 to be retracted automatically into the sheath 11 while not in use. When the finger is sheathed into the sheath 11 to push and move the spring clip 12, the pen 2 will penetrate out of the hole 112. Accordingly, the spring clip 12 can be pushed and moved toward the hole 112, and in a mean time, the pen 2 is penetrated out of the hole 112 for writing. In addition, a proper position of the aforementioned spring clip 12 is provided with plural ridges 123 which facilitate the user to push and move the spring clip 12. On the other hand, the sheath 11 is provided with a ventilation hole 116 for ventilation.

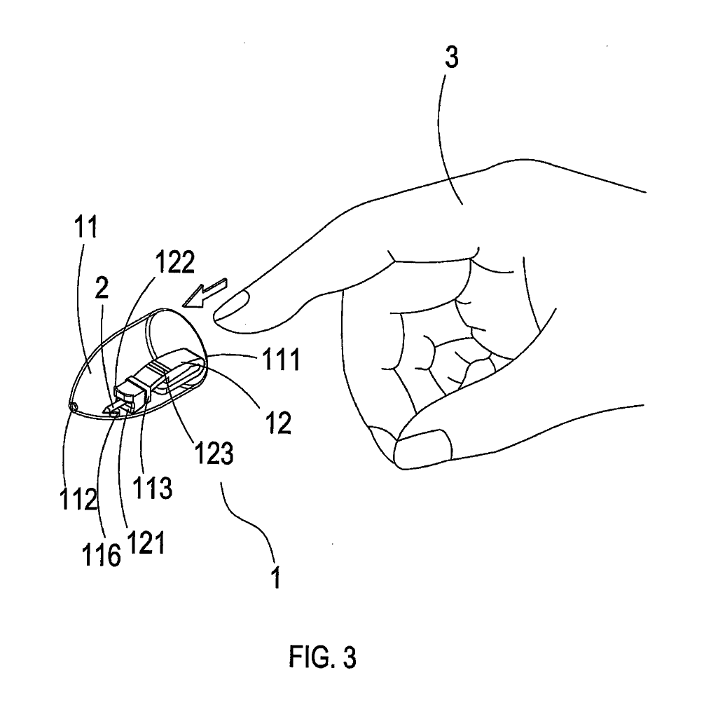

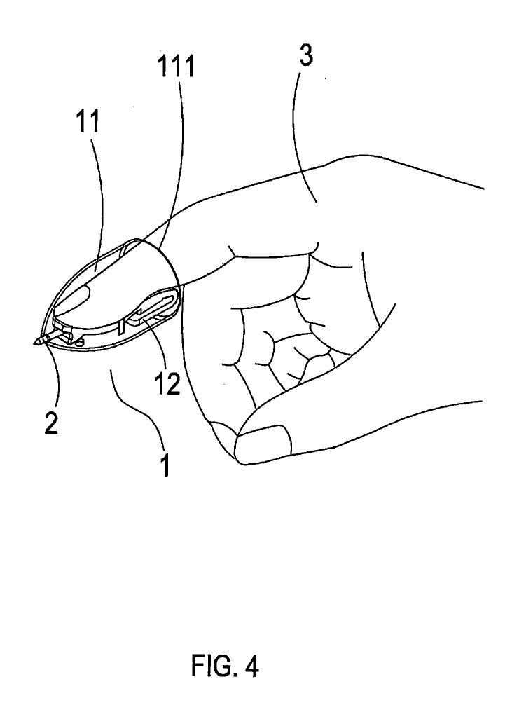

Referring to FIG. 3 and FIG. 4, it shows a first and second schematic view of an operation of a preferred embodiment of the present invention. The finger pen 1 comprises primarily the sheath 11 and the spring clip 12. One end of the sheath 11 is provided with the opening 111 for sheathing in a finger 3, and the other end is provided with the hole 112 allowing the pen 2 to penetrate; whereas, the spacing hole 113 is provided at a place close to the hole 112 to limit the spring clip 12 to operate in a range. An end of the spring clip 12 is provided with the stop block 122 which is engaged with the spacing hole 113; by combining the stop block 122 with the spacing hole 113, the stop block 122 becomes a primary element to limit the movement range of the spring clip 12. Moreover, a proper location of the spring clip 12 is provided with the plural ridges 123 which facilitate the user to push and move the spring clip 12, and the fixing piece 121 is provided on the spring clip 12, away from the place where the spring clip 12 is fixed, to fix the pen 2. When the user is to write, the sheath 11 is sheathed on the finger 3. Before sheathing the sheath 11 on the finger 3, as the spring clip 12 of the sheath 11 is flexible and is provided with elastic tension after bending, at a same time when the finger 3 is sheathed into the sheath 11, the spring clip 12 is pushed inward by the ridges 123 and the stop block 122, using the elastic tension of the spring clip 12 and the ridges 123 as an medium to push the spring clip 12 by the finger 3, and then the pen 2 is penetrated out of the hole 112 and stops until the stop block 122 is abutted on an end of an inner wall of the sheath 11, thereby accomplishing a structural configuration that the finger pen 1 is about to write. On the contrary, when the user stops writing, the finger 3 is removed from the sheath 11, the stop block 122 is then bounced toward the opening 111 through the elastic tension of the spring clip 12 and stops until abutting at the spacing hole 113. Accordingly, the user can write conveniently, and he or she can write easily without holding the pen again whether in driving or outdoors. In addition, as the structures are simple, assembling is very convenient.

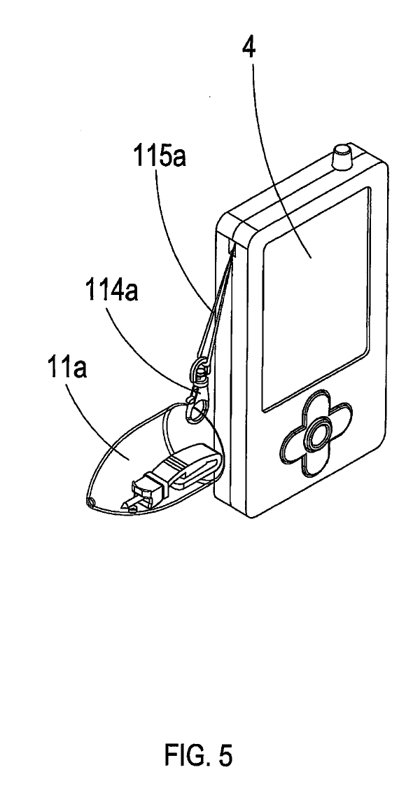

Referring to FIG. 5, it shows a schematic view of an implementation of a first preferred embodiment of the present invention. A side of a sheath 11a is further provided with a fixing ring 114a which is connected with a strap 115a made by a stretchable material. Therefore, the strap 115a can be provided on a PDA 4, facilitating the user to read or write, and further being used for decorating.

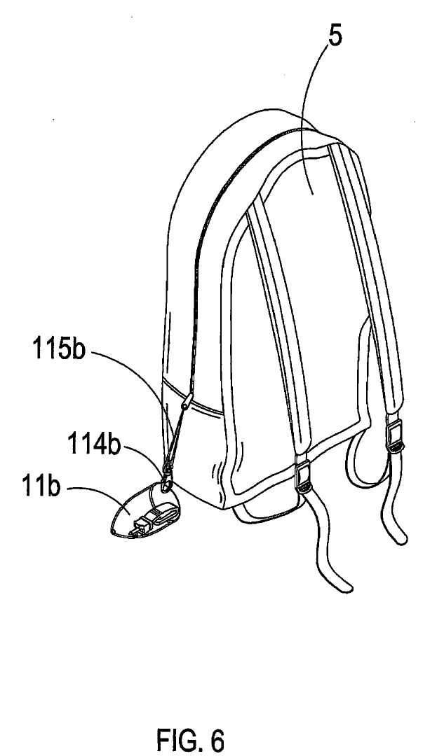

Referring to FIG. 6, it shows a schematic view of an implementation of a second preferred embodiment of the present invention. A side of a sheath 11b is further provided with a fixing ring 114b which is connected with a strap 115b made by a stretchable material. Therefore, the strap 115b can be provided on a bag 5, which facilitates the user to carry, write and read, as well as can be used for decorating.

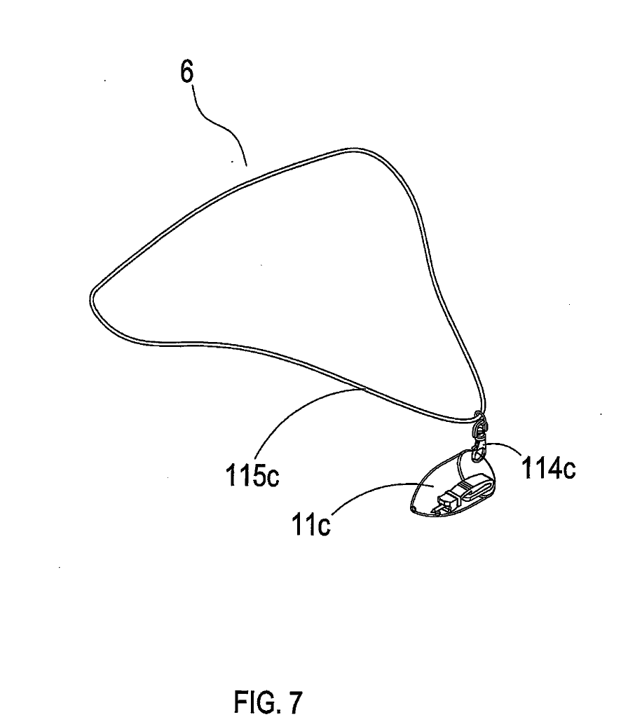

Referring to FIG. 7, it shows a schematic view of an implementation of a third preferred embodiment of the present invention. A side of a sheath 11c is further provided with a fixing ring 114c which is connected with a strap 115c made by a stretchable material. Therefore, the strap 115c can be used as a necklace 6, which facilitates the user to carry, write and read, as well as can be used for decorating. In addition, when the user wears the strap 115c, it is rather pioneered and fashionable.

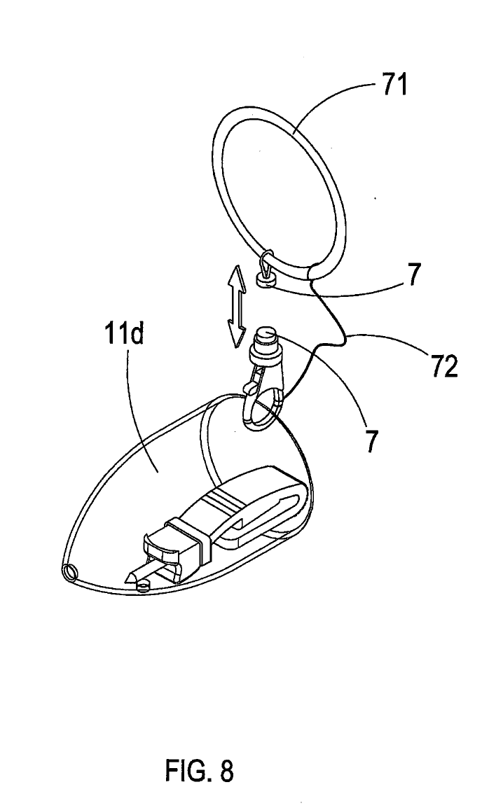

Referring to FIG. 8, it shows a schematic view of an implementation of a fourth preferred embodiment of the present invention. A side of a sheath 11d is further provided with a magnetic fastener 7 which can be connected with a snap ring 71 and a rope 72, such that when the user is to use the magnetic fastener 7, the sheath 11d can be further provided on a bag or oneself, through the magnetic fastener 7. In addition, when using the sheath 11d, one can easily take out for use without limitation, and can absorb the sheath 11d back to the magnetic fastener 7 while not in use.

Referring to all the drawings, the present invention is indeed provided with following advantages:
1. Writing can be carried out by sheathing the finger 3 into the sheath 11, without deliberately taking the pen 2 out of the pen container or using the hand to hold the pen 2.
2. The finger pen 1 is featured with the automatic retractable pen 2, and there will be no condition of leak of ink by forgetting to put on the pen cap.
3. The sheath 11 is small in size and has simple structures. Therefore, the rapid mass production is available and the market competitiveness can be enhanced.
4. The finer pen 1 can fit with a different pattern, achieving an advantage of fashion, beauty and versatility.
5. The sheath 11 is further provided with the fixing ring 114 which can be provided with the strap 115, used as the necklace 6, and hung on the bag 5 or the PDA 4.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A finger pen comprising a sheath, an end of which is provided with an opening for sheathing in a finger, and the other end of which is provided with a hole allowing the pen to penetrate; and a spring clip, and end of which is fixed on the sheath, and a back side at the other end of which is provided with a fixing piece to fix the pen; accordingly, the spring clip being pushed and moved toward the hole, and the pen being penetrated out of the hole to write or read.

2. The finger pen according to claim 1, wherein a spacing hole is provided at a place close to the hole.

3. The finger pen according to claim 1, wherein the spring clip is provided with a stop block away from a place where the spring clip is fixed, to be engaged with the spacing hole.

4. The finger pen according to claim 2, wherein the spring clip is provided with a stop block away from a place where the spring clip is fixed, to be engaged with the spacing hole.

5. The finger pen according to claim 1, wherein a proper position of the spring clip is provided with plural ridges.

6. The finger pen according to claim 1, wherein the spring clip is made by a flexible material.

7. The finger pen according to claim 1, wherein a side of the sheath is further provided with a fixing ring.

8. The finger pen according to claim 7, wherein the fixing ring is connected with a strap.

9. The finger pen according to claim 1, wherein a side of the sheath is further provided with a magnetic fastener.

10. The finger pen according to claim 1, wherein the sheath is provided with a ventilation hole for ventilation.
